(19) United States
(12) Patent Application Publication
(10) Pub. No.: US 2011/0147122 A1
(43) Pub. Date: Jun. 23, 2011

(54) MODULAR FRAME

(75) Inventors: Luke Canham, Nsw (AU); Peter Hartnett, Nsw (AU)

(73) Assignee: LC INDUSTRY PTY LTD., NSW (AU)

(21) Appl. No.: 13/060,158

(22) PCT Filed: Aug. 24, 2009
(86) PCT No.: PCT/AU2009/001076

§ 371 Date: Feb. 22, 2011

(30) Foreign Application Priority Data
Aug. 22, 2008 (AU) 2008904304

(51) Int. Cl. E04G 3/00; E04G 3/20; E04G 7/02; B23P 11/00; F16B 7/00

(52) U.S. Cl. 182/150; 29/428; 403/345; 403/376

(57) ABSTRACT

The present invention provides scaffolding erection methods. One method includes considering whether to attach a scaffold frame support to a building frame from inside, and alternatively, outside the building frame wall. Another comprises attaching a load distribution member to distribute transferred load to at least two wall studs. The present invention also provides scaffolding frame members. One is arranged for connection to a top plate from inside, and alternatively, outside a building frame. Another is a load distributor arranged for distribution across at least two studs of the building frame. The present invention also provides kick board and plank joiners.

### FIELD OF THE INVENTION

The present invention relates broadly to scaffolding and modular and temporary frames or constructions. It relates in particular, though not exclusively, to modular, quick assembly and disassembly, scaffolding.

### BACKGROUND OF THE INVENTION

A number of modular scaffolding frames are currently available. These modular frames typically enable the speed and ease of scaffolding assembly and disassembly to be improved. It is desirable however to provide improved scaffolding methods, components and/or frames to further improve one or more of:
a. Distribution of forces by the scaffolding
b. The speed or ease of scaffolding assembly and disassembly
c. The versatility of scaffolding components.

### SUMMARY OF THE INVENTION

According to one aspect of the present invention there is provided a method of erecting scaffolding comprising the steps of:
a. considering whether to attach a scaffolding frame main support member to a top plate of an unlined building frame from a position which is inside an unlined wall of the building frame, and alternatively, from a position which is outside the building frame wall, the scaffolding frame main support member having an elongate portion and being arranged for connecting a platform support member of a scaffolding frame to a top plate of a building frame for support of the platform support member outside the building frame via the top plate; and
b. attaching the scaffolding frame main support member to the top plate so that the elongate portion of the main support member is positioned on the side of the building frame wall from which the main support member was attached.

The method preferably further comprises attaching the main support member to a top plate of a building frame so that it is positioned either substantially over a wall stud or any other position along the top plate.

The platform support is preferably attached to the main support before the main support is attached to the top plate. However, the platform support may alternatively be attached to the main support after the main support is attached to the top plate.

The method preferably further comprises the step of attaching a main support load distribution member to the main support member wherein the main support load distribution member is arranged to distribute load transferred to the main support member from the platform support to at least two wall studs. The main support load distribution member is preferably attached to the main support member after the main support is attached to the top plate. However, it may alternatively be attached to the main support member before the main support member is attached to the top plate.

According to another aspect of the present invention there is provided a method of erecting scaffolding comprising the steps of:
a. attaching a scaffolding frame main support member to a top plate of an unlined building frame, the scaffolding frame main support member being arranged for connecting a platform support member of a scaffolding frame to a top plate of a building frame for support of the platform support member via the top plate; and
b. attaching a main support load distribution member to the main support member, either before or after the main support member is attached to the top plate, wherein the main support load distribution member is arranged to distribute load transferred, to the main support from the platform support, to at least two wall studs.

The method preferably further comprises the step of supporting the platform support member outside the building frame. In another preferred form the method of this other aspect of the present invention further comprises the step of attaching the scaffolding frame main support member to the top plate from a position which is inside an unlined wall of the building frame, and alternatively, from a position which is outside the building frame wall. The scaffolding frame main support member preferably comprises an elongate portion and the method preferably further comprises the step of attaching the scaffolding frame main support member to the top plate so that the elongate portion of the main support member is positioned on the side of the building frame wall from which the main support member was attached.

According to another aspect of the present invention there is provided a scaffolding frame main support member arranged for connecting a platform support member of a scaffolding frame to a top plate of a building frame and support of the platform support member via the top plate wherein the scaffolding frame main support member is arranged for attachment to the top plate from inside, and alternatively, outside the building frame and support of the platform support outside the building frame.

The scaffolding frame main support member preferably further comprises a main support load distributor arranged for attachment to the main support member and distribution, across at least two studs of the building frame, of load transferred, when the main support member is attached to the top plate and supporting the platform support, from the platform support to the main support.

According to a another aspect of the present invention there is provided a scaffolding frame main support load distribution member arranged for attachment to a main support member of a scaffolding frame, the main support member being arranged for connecting a platform support member of a scaffolding frame to a top plate of a building frame and support of the platform support member via the top plate, wherein the main support load distribution member is arranged for distributing across at least two studs of the building frame load transferred, when the main support member is attached to the top plate and supporting the platform support, from the platform support to the main support.

According to another aspect of the present invention there is provided a modular apparatus for constructing scaffolding, the modular apparatus comprising:
a. a scaffolding frame main support member for supporting a scaffolding frame via a top plate of a building frame; and
b. a platform support member for supporting a platform; wherein
   the scaffolding frame main support member is arranged for attachment to the top plate from inside, and alternatively, outside the building frame and connection to the platform support member for support of the platform support member outside the building frame.

According to another aspect of the present invention there is provided a scaffolding frame assembly comprising:
a. a scaffolding frame main support member for supporting a scaffolding frame via a top plate of a building frame; and
b. a platform support member for supporting a platform; wherein
   the scaffolding frame main support member is arranged for attachment to the top plate from inside, and alternatively, outside the building frame and connection to the platform support member for support of the platform support member outside the building frame.

The scaffolding frame assembly is preferably modular.

The modular apparatus and scaffolding frame assembly preferably further comprise a main support load distribution member arranged for attachment to the main support member and distribution, across at least two studs of the building frame, of load transferred, when the main support member is attached to the top plate and supporting the platform support, from the platform support to the main support.

The modular apparatus and scaffolding frame assembly preferably further comprise a platform rail support member arranged for supporting one or more platform rails relative to the platform support member and thereby preventing a person falling from the platform. The platform rail support member is preferably arranged for attachment to the platform support. The platform rail support member may be arranged for detachable attachment to the platform support for adjustment of its position relative to the platform support thereby allowing adjustment of platform rail positions. The modular apparatus and scaffolding frame assembly preferably further comprise both fixed and detachable platform rail support members.

The platform rail support member is preferably also arranged for attachment thereto of a rail support post. For this purpose the platform rail support member preferably comprises a platform rail support post tube designed to slideably receive a platform rail support post. The platform rail support post is preferably a tube having a section corresponding to that of the platform rail support post tube.

The modular apparatus and scaffolding frame assembly preferably further comprise one or more of the platform rails.

The main support member preferably comprises a U-Shaped attachment portion. The U-shaped attachment portion preferably comprises a U-shaped channel. However, the U shaped attachment portion, may, for example, comprise at least one U shaped strap. The U-shaped attachment portion preferably further comprises main support location means for locating and preferably securing the main support relative to the top plate. The main support location means preferably comprises one or more bolts arranged for threadable engagement with the attachment portion.

The main support member preferably further comprises an elongate portion. The attachment portion preferably extends from one end of the elongate portion. The elongate portion preferably comprises a tube. In one preferred form of the present invention the tube is square or rectangular in section. However, it may also, for example, be round.

The main support member is preferably arranged for attachment to a top plate of a building frame so that it is positioned either substantially over a wall stud or any other position along the top plate.

The main support load distributor and main support load distribution member preferably comprise a load distribution rail arranged for contacting the two or more studs when the main support is attached to the building frame top plate. In one preferred form the load distribution rail is arranged for removable slidable engagement with the remainder of the main support load distribution member.

The main support load distribution member and platform support member are each preferably arranged for detachable attachment to the main support member. However, in an alternative embodiment one or both of them may be integrally formed with the main support member.

The main support load distribution member and platform support member are each preferably arranged for engagement with the elongate portion of the main support. In one preferred form the main support load distribution member and platform support member comprise engagement portions arranged for engagement with the elongate portion of the main support. The rail support member preferably similarly comprises an engagement portion for engagement with and attachment to the platform support. The engagement portions preferably, comprise, in the case of the main support load distribution member and platform support, tubes corresponding in cross section to the elongate portion and arranged for slidably receiving the elongate portion. The engagement portion of the rail support preferably comprises an engagement channel. The engagement portions and corresponding portions of the main support and platform support members preferably comprise corresponding holes for passage of, for example, one or more bolts or pins there through to adjustably locate and preferably secure the engagement portions relative to the corresponding members.

The main support load distribution member preferably further comprises another engagement portion. The other engagement portion is preferably arranged for engagement with the main support member when the main support member is attached to a top plate of a building frame so that the main support member is in an alternate orientation with respect to the building frame. For example, the main support member can be positioned for attachment to a top plate of a building frame from a position which is outside the building frame. The main support can alternately be positioned for attachment to a top plate of a building frame from a position which is inside the building frame. The other engagement portion is preferably substantially identical to the engagement portion but offset relative to it for engagement with the main support when it is alternately orientated relative to the building frame. The other engagement portion is preferably arranged for engagement with the main support so that the position of the main support load distribution member, when it is attached to the main support member and the main support member is attached to a top plate of a building frame, is substantially the same as for the engagement portion.

In one preferred form the platform support member comprises a platform support arm.

According to a another aspect of the present invention there is provided a rail joiner, the rail joiner having one or more receptacles arranged to join end portions of substantially collinear rails in abutting, and alternatively, overlapping relationship to provide a joined rail.

According to another aspect of the present invention there is provided a modular apparatus for constructing rails, the modular apparatus comprising:
a. a rail joiner; and
b. corresponding rails; wherein
   the rail joiner having one or more receptacles arranged to join end portions of substantially collinear rails in abutting, and alternatively, overlapping relationship to provide a joined rail.

According to another aspect of the present invention there is provided a rail assembly comprising:
a. a rail joiner; and
b. corresponding rails; wherein
   the rail joiner having one or more receptacles arranged to join end portions of substantially collinear rails in abutting, and alternatively, overlapping relationship to provide a joined rail.

The one or more rail joiner receptacles preferably comprise connected bands for connecting two or more rails, one of the bands being arranged for location within or passage there through of an end of a rail, and alternatively, an end of the rail and ends of one or more other rails, and the other band being arranged for location within or passage there through of ends of the one or more other rails, and alternatively, ends of the one or more other rails and an end of the rail. The bands may in an alternative embodiment comprise ends of a tube. However, in this alternative embodiment it is preferred that the tube is at least partially transparent or translucent to facilitate assembly of the rails and rails joiner.

The bands are preferably rectangular in cross section.

According to a another aspect of the present invention there is provided another rail joiner, the other rail joiner being arranged to join end portions of rails lying in substantially transverse planes and comprising engagement portions for engaging the rails to provide a joined rail, wherein at least one of the engagement portions is arranged for axial movement relative to the corresponding rail to facilitate adjustment of a position of an end of that rail.

According to another aspect of the present invention there is provided a modular apparatus for constructing a rail, the modular apparatus comprising:
a. another rail joiner; and
b. corresponding rails; wherein
   the other rail joiner is arranged to join end portions of rails lying in substantially transverse planes and comprises engagement portions for engaging the rails to provide a joined rail wherein at least one of the engagement portions is arranged for axial movement relative to the corresponding rail to facilitate adjustment of a position of an end of that rail.

According to another aspect of the present invention there is provided a rail assembly comprising:
a. another rail joiner; and
b. corresponding rails; wherein
   the other rail joiner is arranged to join end portions of rails lying in substantially transverse planes and comprises engagement portions for engaging the rails to provide a joined rail wherein at least one of the engagement portions is arranged for axial movement relative to the corresponding rail to facilitate adjustment of a position of an end of that rail.

One of the engagement portions preferably comprises opposed hooks arranged for location there between of an end portion of a rail. The hooks are preferably U shaped brackets. In one preferred embodiment the U shaped brackets are connected by a strap of the same width to form a C shaped engagement portion. The strap and U shaped brackets may comprise a single homogeneous member.

The other engagement portion preferably comprises a protrusion arranged for receipt within an end portion of a rail. The protrusion preferably comprises a tube. The tube is preferably square in section for receipt within a square sectioned rail.

The rail joiner and other rail joiner are preferably arranged to join two or more connected rails which collectively form a balustrade. In a more preferred form the rail joiner and other rail joiner are corresponding kick board joiners arranged to join kick boards. The kick board may, for example, comprise a scaffolding frame kick board.

According to a another aspect of the present invention there is provided a deck joiner, the deck joiner having one or more receptacles arranged to join edges of two or more substantially coplanar decks in abutting relationship to provide a joined deck.

According to another aspect of the present invention there is provided a modular apparatus for constructing decking, the modular apparatus comprising:
a. a deck joiner; and
b. corresponding decks; wherein
   the deck joiner has one or more receptacles arranged to join edges of two or more substantially coplanar decks in abutting relationship to provide a joined deck.

According to another aspect of the present invention there is provided a decking assembly comprising:
a. a deck joiner; and
b. corresponding decks; wherein
   the deck joiner has one or more receptacles arranged to join edges of two or more substantially coplanar decks in abutting relationship to provide a joined deck.

The one or more receptacles of the deck joiner preferably comprise a sleeve arranged to receive and locate therein the deck edges. In a further preferred embodiment the deck joiner comprises a deck edge locator which is arranged to locate ends of the deck edges substantially midway along the longitudinal length of the sleeve. The deck joiner preferably further comprises an inspection hole.

The sleeve is preferably rectangular in section.

The deck joiner is preferably a plank joiner arranged to join end edges of two substantially coplanar planks in abutting relationship to provide joined planks.

### BRIEF DESCRIPTION OF THE FIGURES

A preferred embodiment of a modular scaffolding frame of the present invention will now be described, by way of example only, with reference to the accompanying figures in which:

FIG. 1 is a perspective view of one example of an assembled modular scaffolding frame;

FIG. 1a is a plan view of the assembled modular scaffolding frame of FIG. 1;

FIG. 1b is a side view of the assembled modular scaffolding frame of FIG. 1;

FIG. 1c is a rear elevational view of the assembled modular scaffolding frame of FIG. 1 attached to a building frame;

FIG. 2 is a perspective view of the assembled modular scaffolding frame of FIG. 1 attached to a building frame;

FIG. 3 is a perspective view of two assembled modular scaffolding frames of FIG. 1 attached to adjacent walls of a building frame;

FIG. 3a is a perspective view similar to that of FIG. 3 but viewed from the inside of the building frame;

FIG. 3b is a plan view of the modular scaffolding frame of FIG. 3;

FIG. 3c is an elevational view of the modular scaffolding frame of FIG. 3;

FIG. 3d is another elevational view of the modular scaffolding frame of FIG. 3;

FIG. 4 is a perspective view of the assembled modular scaffolding frame of FIG. 1 attached to a building frame from inside rather than outside the building frame;

FIG. 4a is a plan view of the assembled modular scaffolding frame of FIG. 4;

FIG. 4b is a side elevational view of the assembled modular scaffolding frame of FIG. 4;

FIG. 4c is a rear elevational view of the assembled modular scaffolding frame of FIG. 4;

FIG. 5 is a perspective view similar to that of FIG. 4 but viewed from outside, rather than inside, the building frame;

FIG. 6 is a perspective view of the assembled modular scaffolding frame of FIGS. 1 and 4;

FIGS. 7 and 8 are respective side and front elevational views of the assembled frame of FIG. 6;

FIG. 9 is a perspective view of one example of a main support load distributor or main support load distribution member of the modular scaffolding frame of Figures and 1 and 4;

FIGS. 10 and 11 are respective side and plan views of the main support load distributor or distribution member of FIG. 9;

FIG. 12 is a perspective view of a platform support arm of the modular scaffolding frame of FIGS. 1 and 4;

FIGS. 13 and 14 are respective side and plan views of the platform support arm of FIG. 12;

FIG. 14a is an underneath view of the platform support arm of FIG. 12;

FIGS. 15, 16 and 17 are respective side, rear and plan views of a platform rail support of the modular scaffolding frame of FIGS. 1 and 4; and

FIG. 17b is an underneath plan view of the platform rail support;

FIGS. 18 and 19 are respective front and side views of a platform rail support post of the modular scaffolding frame of FIGS. 1 and 4.

FIG. 18a is a perspective view of the platform rail support post;

FIG. 18b is a rear elevational view of the platform rail support post;

FIG. 20 is a perspective view of the main support of the modular scaffolding frame of FIGS. 1 and 4;

FIG. 21 is a side elevational view of the main support of FIG. 20;

FIG. 22 is a plan view of the main support of FIG. 20;

FIG. 23 is a perspective view of one example of a plank sleeve of the present invention;

FIG. 24 is a plan view of the plank sleeve of FIG. 23;

FIG. 25 is an end elevational view of the plank sleeve of FIG. 23;

FIG. 26 is a perspective view of one example of a corner sleeve of the present invention;

FIG. 27 is a plan view of the corner sleeve of FIG. 26;

FIG. 28 is a side elevational view of the corner sleeve of FIG. 26;

FIG. 29 is an underneath view of the corner sleeve of FIG. 26;

FIG. 30 is a perspective view of one example of a slide chassy of the present invention;

FIG. 31 is an end elevational view of the slide chassy of FIG. 30;

FIG. 32 is a side view of the slide chassy of FIG. 30;

FIG. 33 is a perspective view of one example of a kickboard of the present invention;

FIG. 34 is a side elevational view of the kickboard of FIG. 33;

FIG. 35 is a perspective view of one example of a corner slide of the present invention;

FIG. 36 is a plan view of the corner slide of FIG. 35;

FIG. 37 is a side elevational view of the corner slide of FIG. 35;

FIG. 38 is an exploded perspective view of a slide chassy and kickboards prior to assembly;

FIG. 39 is a plan view of the slide chassy and kickboards of FIG. 38;

FIG. 40 is a perspective view of assembled slide chassy and kickboards of FIG. 38;

FIG. 41 is a plan view of the assembled slide chassy and kickboards of FIG. 38;

FIG. 42 is a perspective view similar to that of FIG. 38 but in relation to a corner slide and corresponding kickboards;

FIG. 43 is a plan view of the corner slide and kickboards of FIG. 42;

FIG. 44 is a perspective view similar to that of FIG. 40 but showing assembly of a corner slide and kickboards;

FIG. 45 is a plan view of the assembled corner slide and kickboards of FIG. 42;

FIG. 46 is a perspective view of one example of a corner sleeve of the present invention supporting kickboards connected via a corner slide;

FIG. 47 is a plan view of the assembled corner sleeve, kickboards and corner slide of FIG. 46;

FIG. 48 is an elevational view of the assembly of FIGS. 46 and 47;

FIG. 49 is another elevational view of the assembled components of FIGS. 46, 47 and 48;

FIG. 50 is an exploded perspective view of the plank sleeve of FIGS. 23 to 25 showing one example of planks of the current invention positioned for assembly with the plank sleeve;

FIG. 51 is a plan view of the components of FIG. 50 positioned for assembly;

FIG. 52 is a perspective view of the plank sleeve and planks of FIG. 50 assembled; and

FIG. 53 is a plan view of the assembled plank sleeve and planks of FIG. 52.

### DETAILED DESCRIPTION OF THE INVENTION

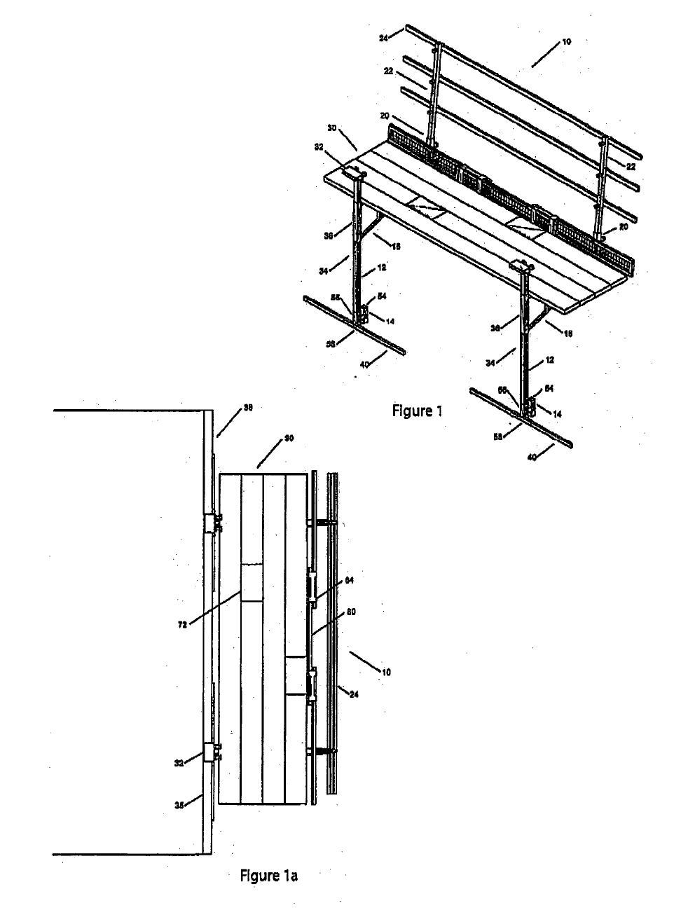

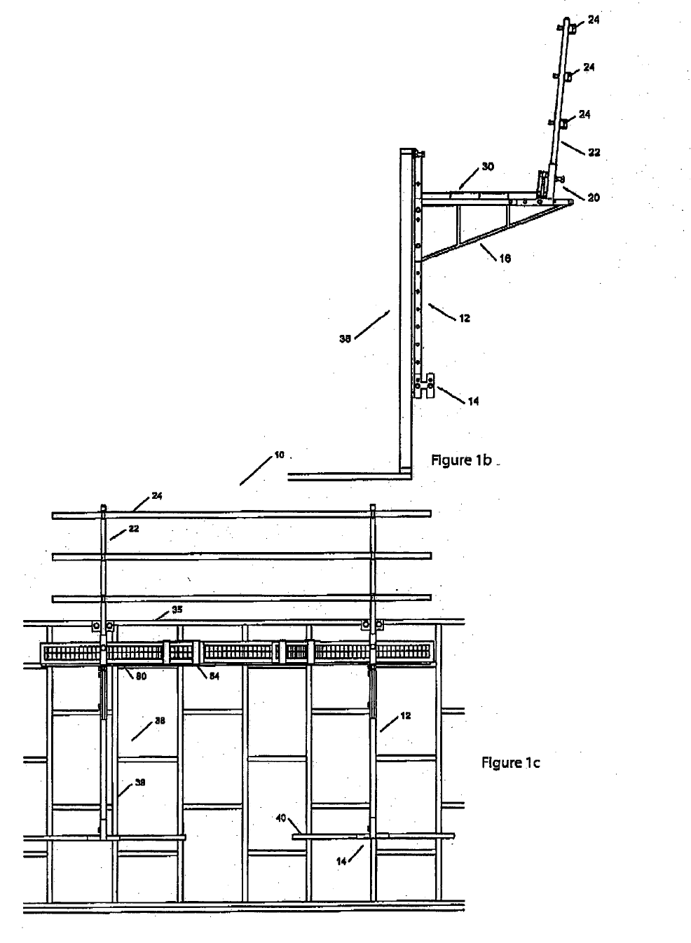

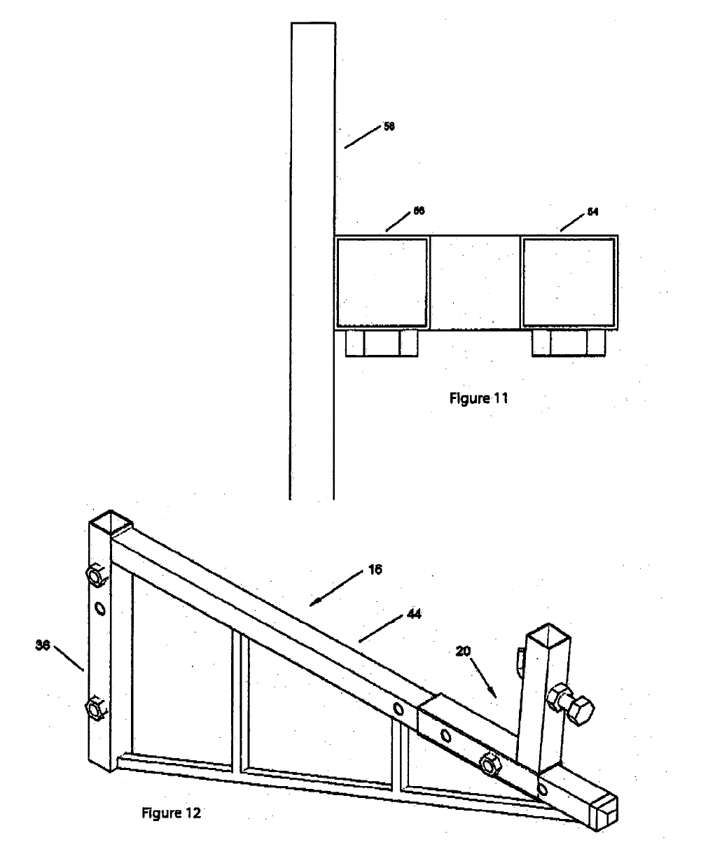

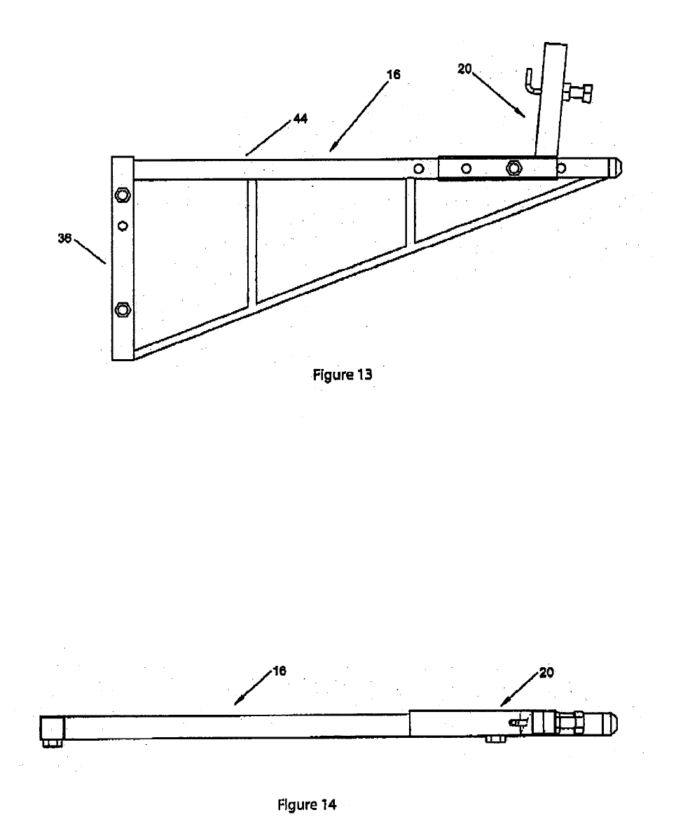

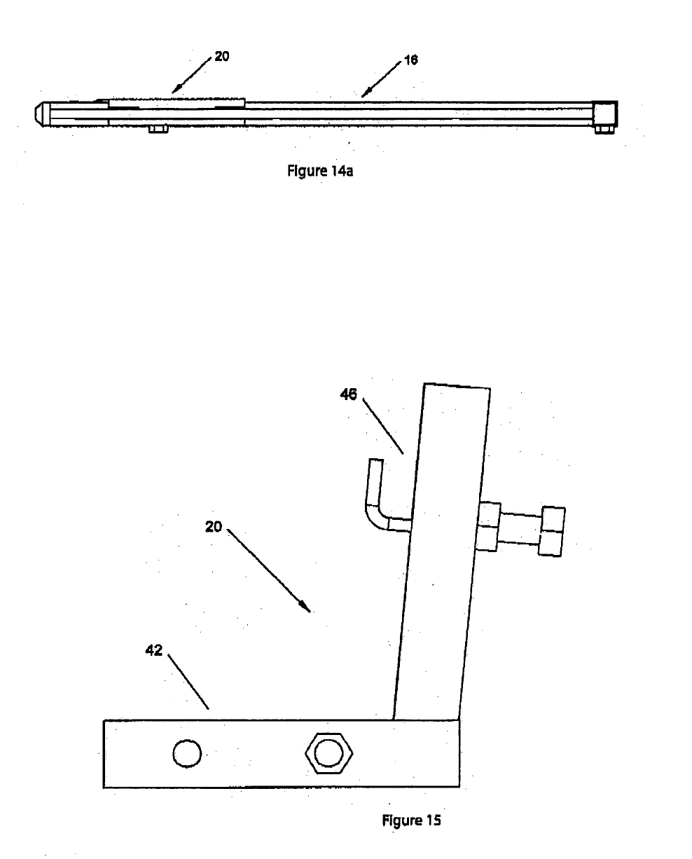

Referring to FIGS. 1, 2 and 3 one example of a modular scaffolding frame assembly of the present invention comprises modular scaffolding frame 10. The scaffolding frame 10 generally comprises a main support member, which in this particular example comprises main support 12, a main support load distributor or load distribution member in the form of main support load distributor 14 and a platform support member in the form of support arm 16. The main support load distributor 14 and support arm 16 are shown in more detail in respective FIGS. 9-11 and 12-15. The modular scaffolding frame further comprises platform rail supports which in this particular example comprise rail support 20, platform rail posts in the form of rail posts 22, and platform rails 24. The support arm supports platform 30.

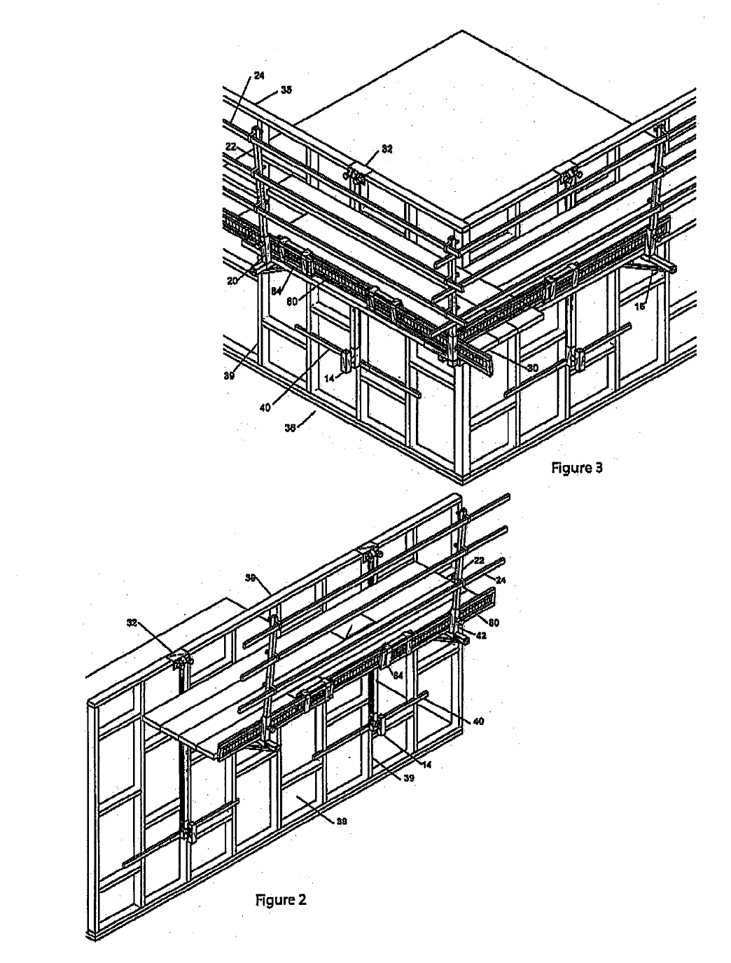

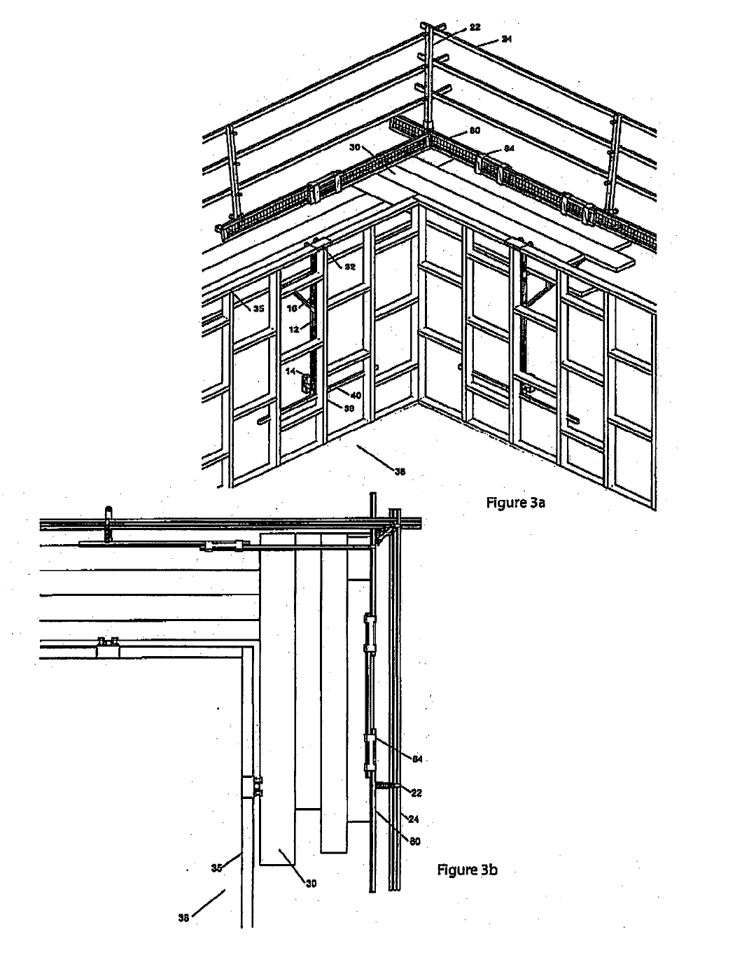

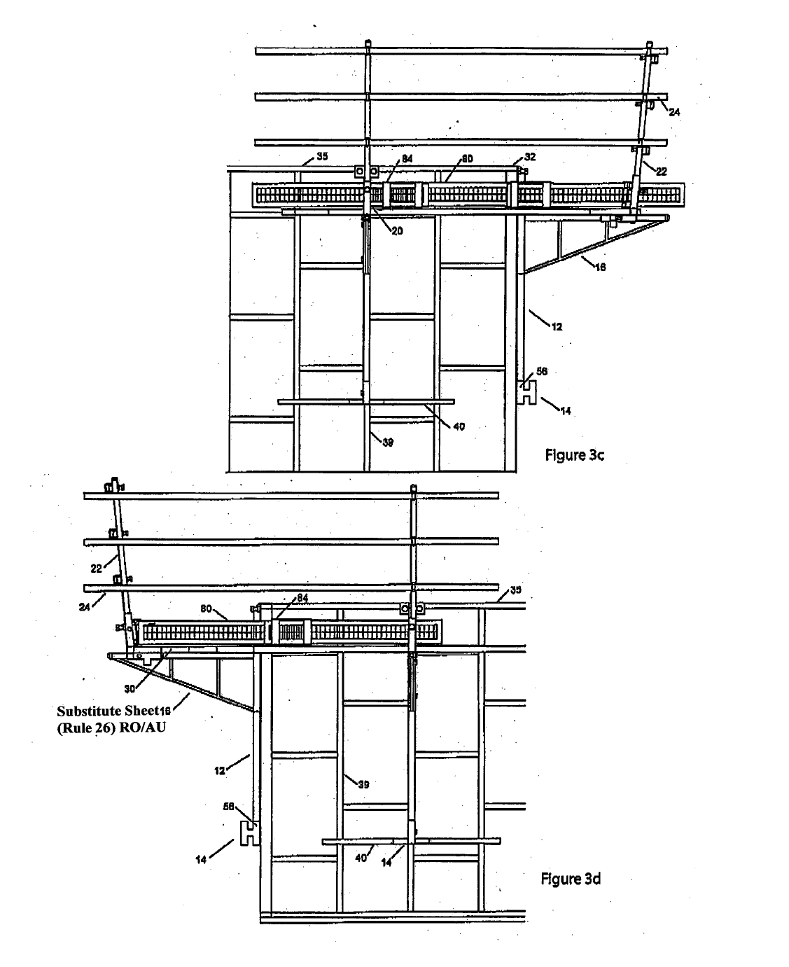

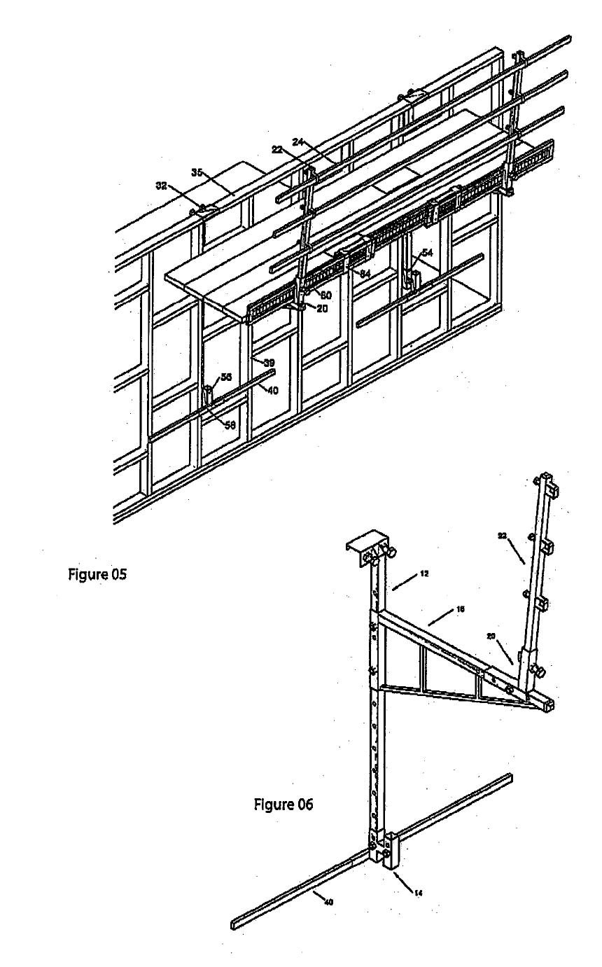

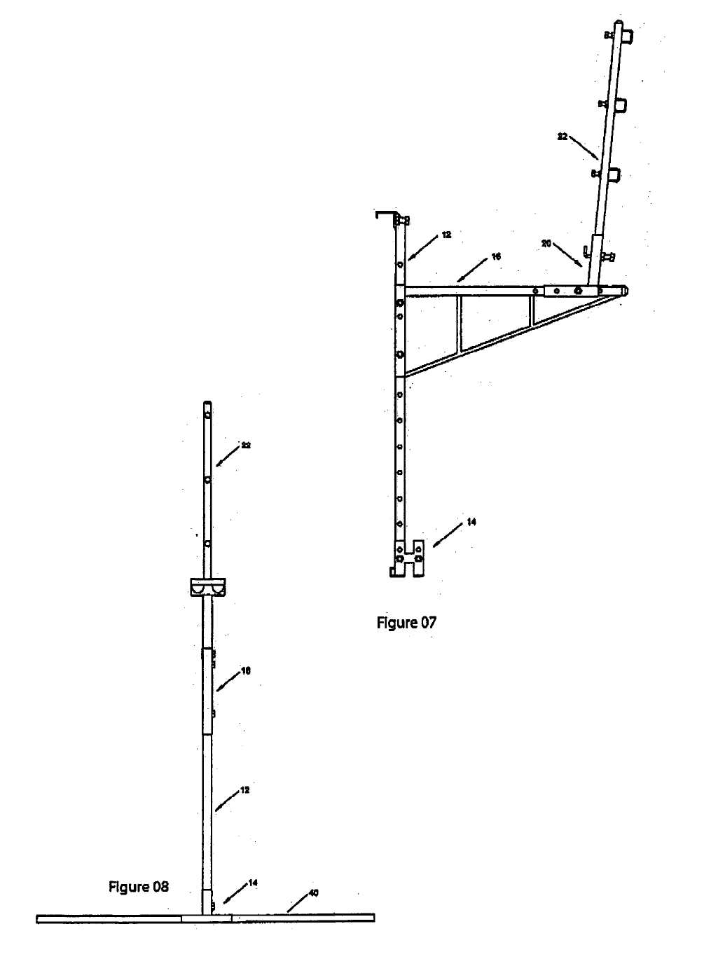

Referring to FIGS. 6, 7 and 8 the main support 12 comprises a main support attachment portion in the form of attachment bracket 32. The attachment bracket 32 is designed to hook over a top plate 35 of building frame 38 (see FIGS. 2 and 3). An elongate portion of the main support in the form of a tube 34 extends downwardly away from the attachment bracket 32 when the main support 12 is appropriately attached to the top plate 35. Referring also to FIGS. 1 and 12-15, the support arm 16 attaches to the main support 12 via the tube 34. The support arm 16 comprises tube 36 having a cross section corresponding to that of the tube 34 and is thereby designed to slideably receive that tube. The support arm 16 is located relative to the main support 12 by bolts which threadably engage the support arm 16 and engage the tube 34 via threaded holes of the tube 36.

As can been seen from FIGS. 1-3 and 6-8, when platform 30 is supported by the support arm 16, a downward force is applied to the support arm. The support arm 16 in turn applies a rotational force to the main support 12 via the tube 34 and about the attachment bracket 32. This forces the tube 34 of the main support 12 toward the building frame 38. This force applied to the tube 34 is spread over at least two wall studs 39 (see FIG. 2) by a load distributor rail which in this preferred embodiment is load distributor bar 40 (best seen in FIGS. 1 and 2). As will be readily appreciated by persons skilled in the relevant art, the load distributor rail could alternatively, for example, comprise a load distributor strap or shaft. The Load distributor bar 40 slidably engages the remainder of the main support load distributor 14. The main support load distributor 14 is slidably attached to the main support 12 via tube 56 of the main support load distributor 14 (best seen in FIGS. 1 and 9). The main support load distributor 14 is located and secured relative to the main support 12 in a similar manner to that described in relation to the support arm 14 and main support 12.

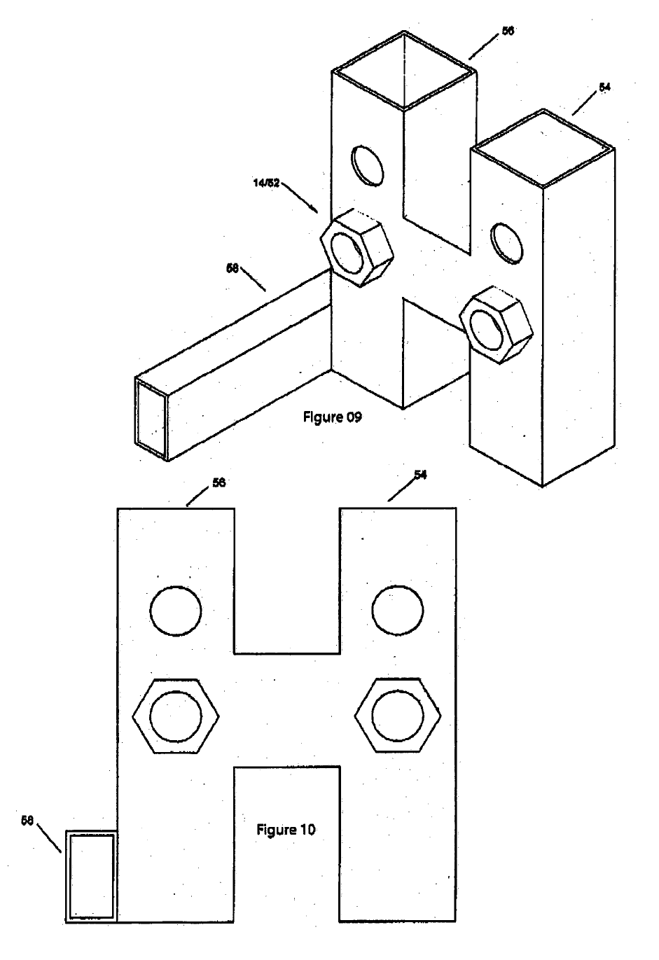

The slidable nature of the load distributor bar 40 enables its position relative to the tube 34 of the main support 12 to be adjusted to appropriately contact wall studs 42 of the building frame 38. This feature, in combination with the length of the load distributor bar 40, ensures the bar 40 can be positioned to contact at least three wall studs 39 regardless of the position along the top plate where the attachment bracket 32 is attached. In this way the rotational force applied to the main support 12 can be spread over three wall studs. The load distributor bar 40 is located and secured relative to the main support load distributor 14 in a similar manner to that described in relation to the support arm 14 and main support 12. A threaded hole 41 designed to receive a locating bolt (not shown) is shown in FIGS. 10 and 11.

Referring again to FIGS. 1-3 and 6-8, the rail supports 20 are designed for detachable attachment to the support arm 16. An alternative platform support member comprises a support arm (not shown) having a rail support which is integrally formed with the support arm.

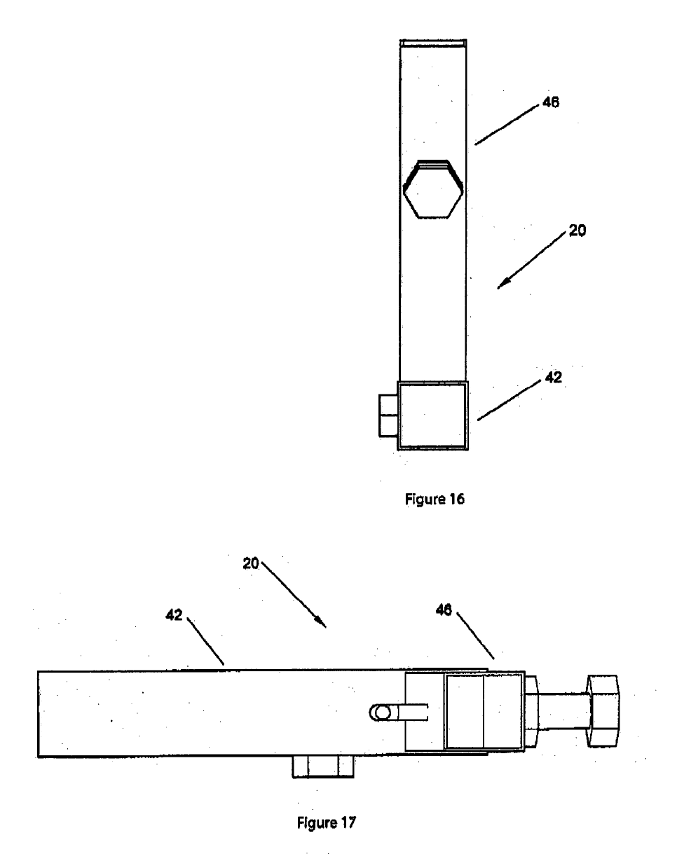

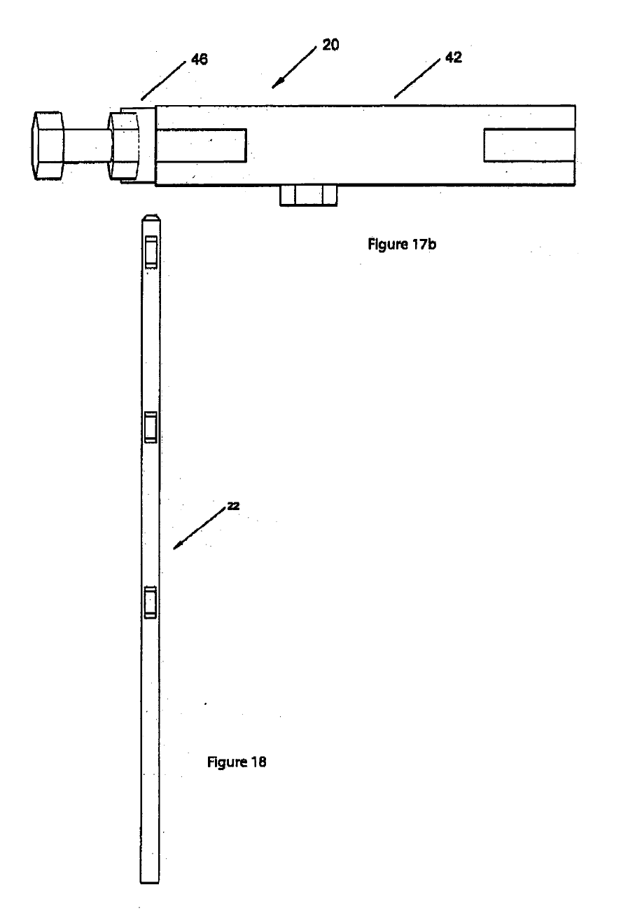

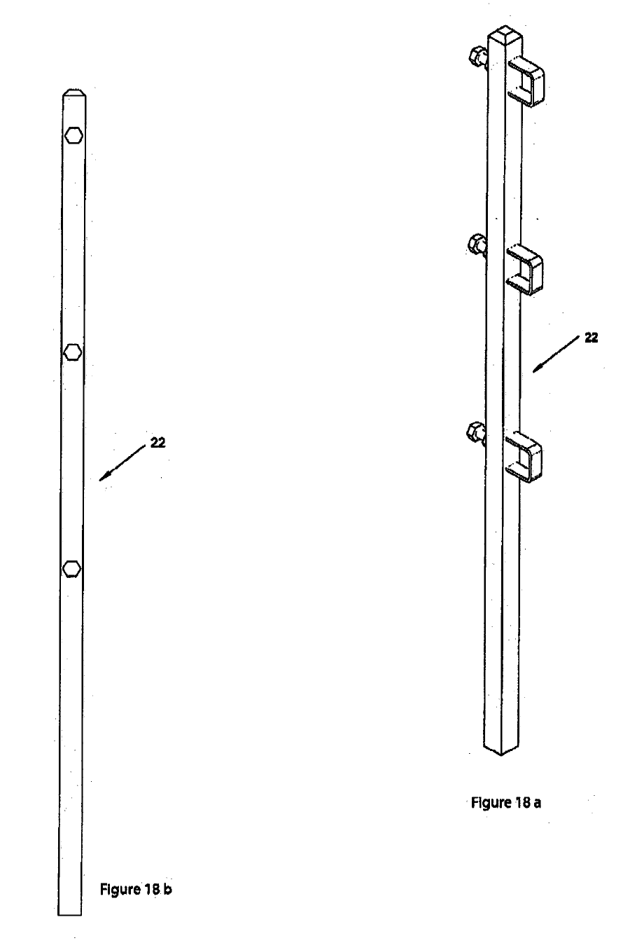

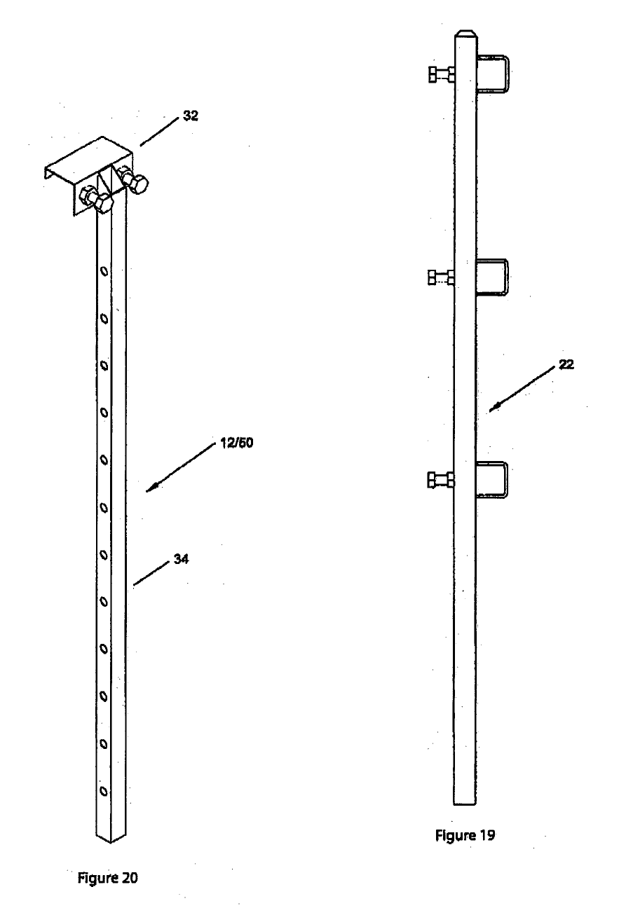

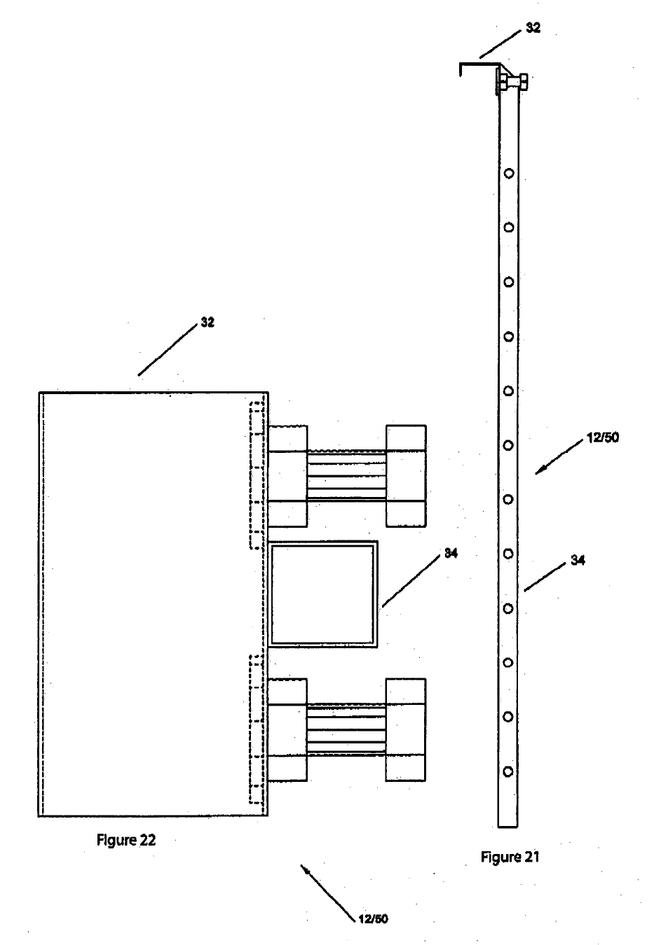

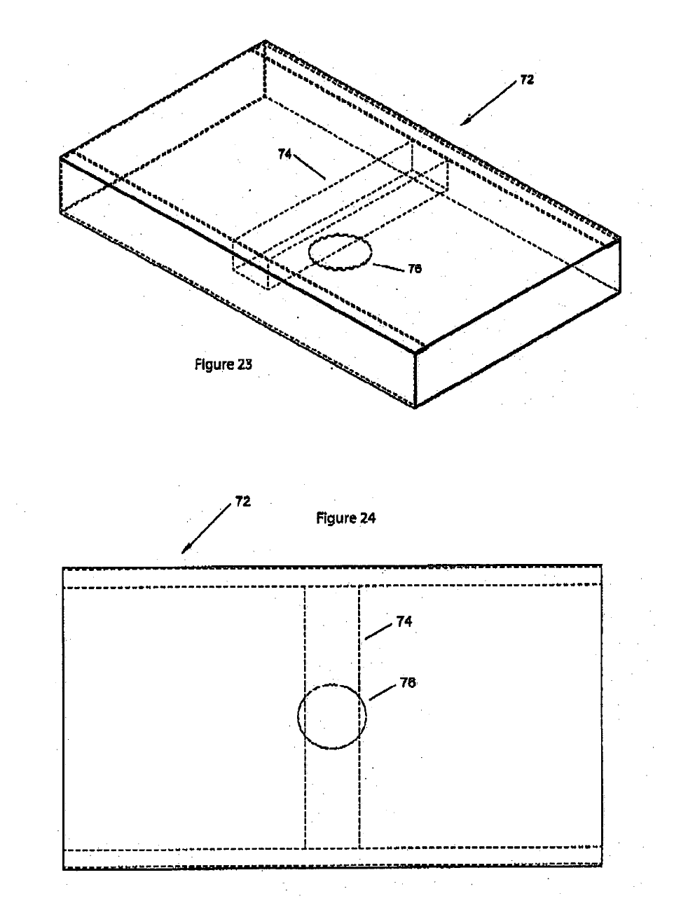

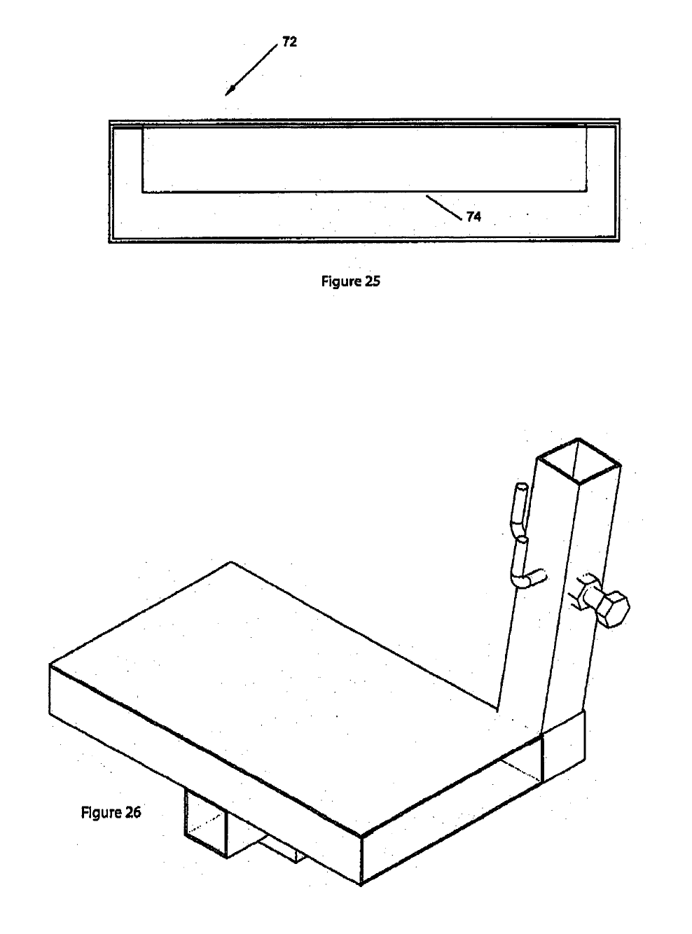

Referring to FIGS. 15-17 the rail supports 20 comprise a channel 42 which is designed to fit over a tube 44 of the support arm 16. The rail supports 20 also include a tube 46 which extends transversely of the channel 42. The channel 42 enables the position of the rail supports 20 to the adjusted relative to the tube 44. This adjustment in turn enables the position of the rails 24 to be adjusted. The rail supports 20 are secured to the support arm 16 in a similar manner to that which the support arm 14 is secured to the main support 12.

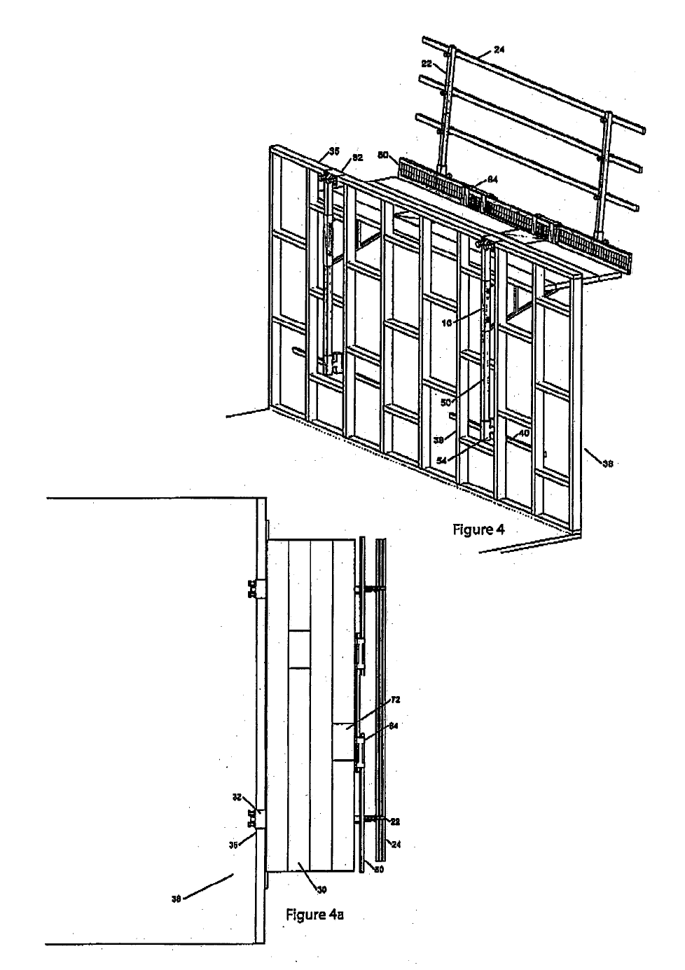

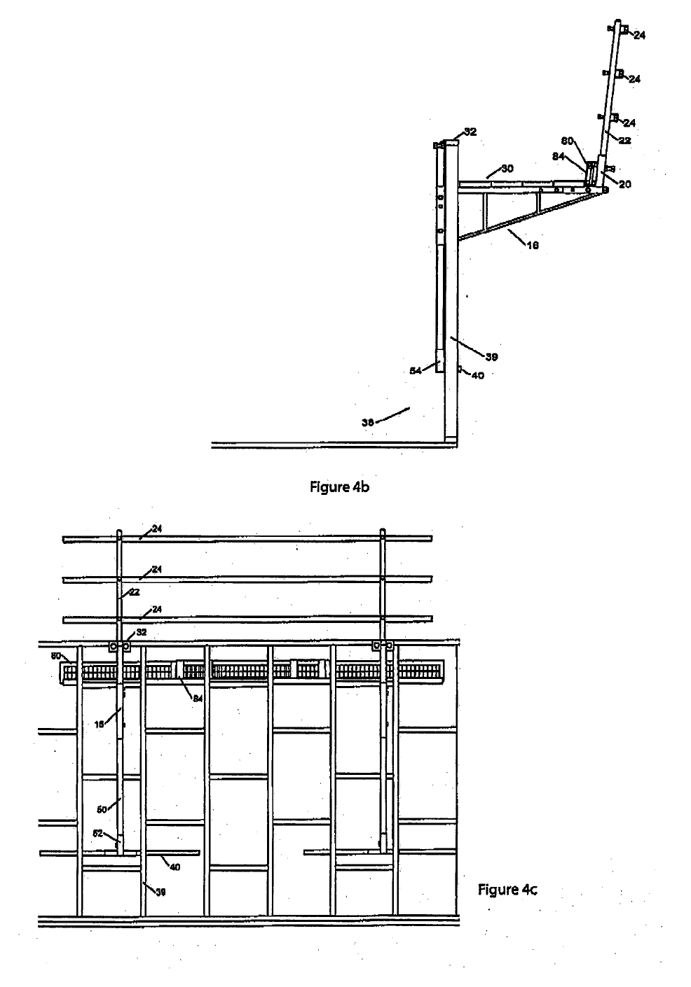

FIGS. 4 and 5 represent another example of the modular scaffolding frame assembly 10, in the form of modular scaffolding frame assembly 48. This other example involves assembly of the frame so that the main support is positioned inside building frame 38. A main support 50 of the modular scaffolding frame assembly 48 is orientated 180 degrees relative to the main support 12 of the modular scaffolding frame assembly 10. A main support load distributor 52 is also orientated 180 degrees relative to its orientation in FIGS. 1-3 so that tube 54 rather than tube 56 slideably receives the main support tube 34 (see also FIGS. 1 and 9-11). In this way a strap holder 58 (best seen in FIGS. 1 and 9) of the main support load distributor 52 is positioned so that the load distributor strap 40 still contacts outer surfaces of the wall studs 42.

The modular scaffolding frame assembly 10 is designed for fitting to building frame 38 from outside the frame. However, the modular scaffolding frame assembly 48 is designed as shown in FIGS. 4 and 5, to be fitted to building frame 38 from inside. In some situations it is difficult to attach the modular scaffolding frame assembly to a building frame from outside the frame. It may, for example, be difficult if the terrain surrounding the building frame is unlevel or drops sharply away. It is also difficult if the scaffolding relates to a second story or higher of a multistory building. The modular scaffolding frame assembly 48 therefore facilitates scaffolding erection in these types of situations by enabling it to be erected from an internal floor of the building to which the scaffolding is to be attached.

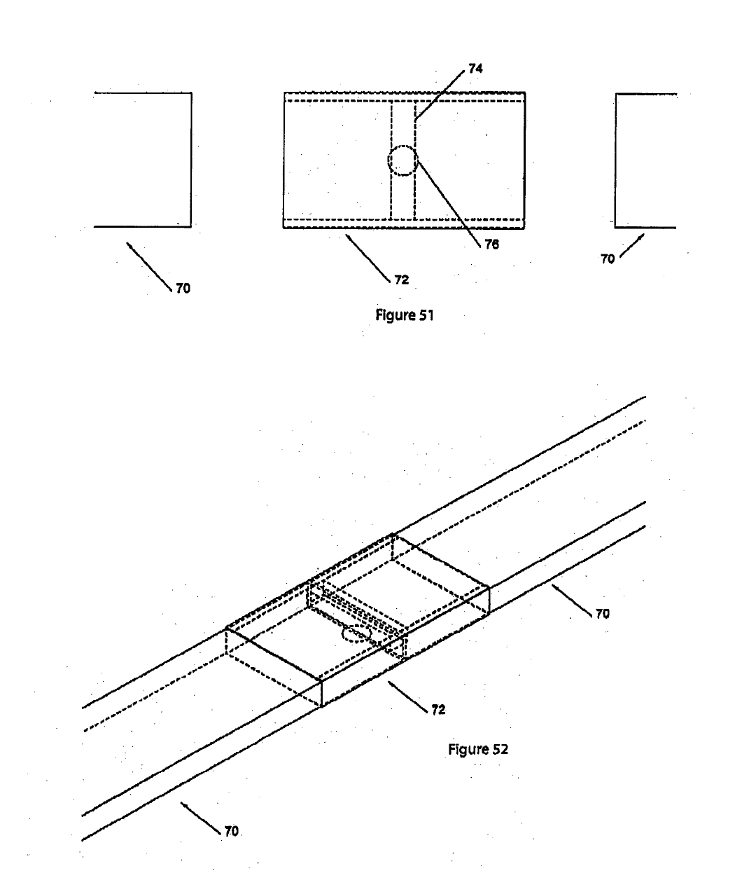

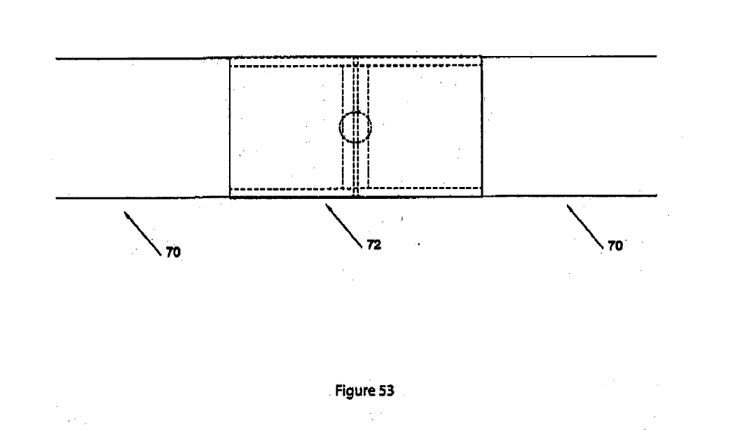

Referring to FIGS. 1 to 5 and 50 to 53 it can be seen that scaffolding frame assemblies 10 and 48 also include planks 70 and plank joiners in the form plank sleeves 72. It can be seen from these figures that the plank sleeves 72 have deck edge locators in the form of separator tags 74 and an inspection hole in the form of hole 76. The plank sleeves enable planks to be securely joined as is readily evident from the figures to a person skilled in the relevant art.

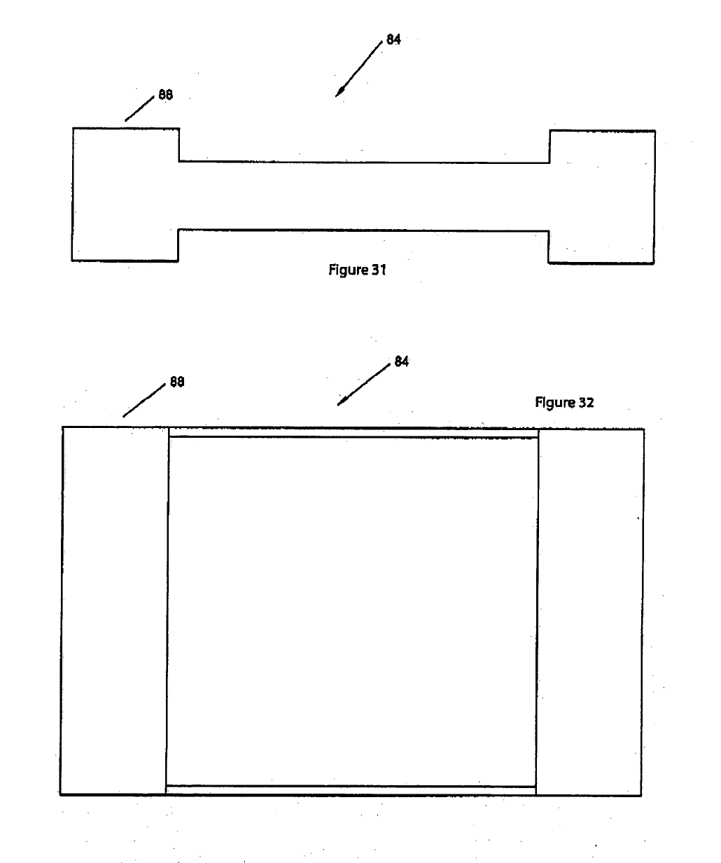

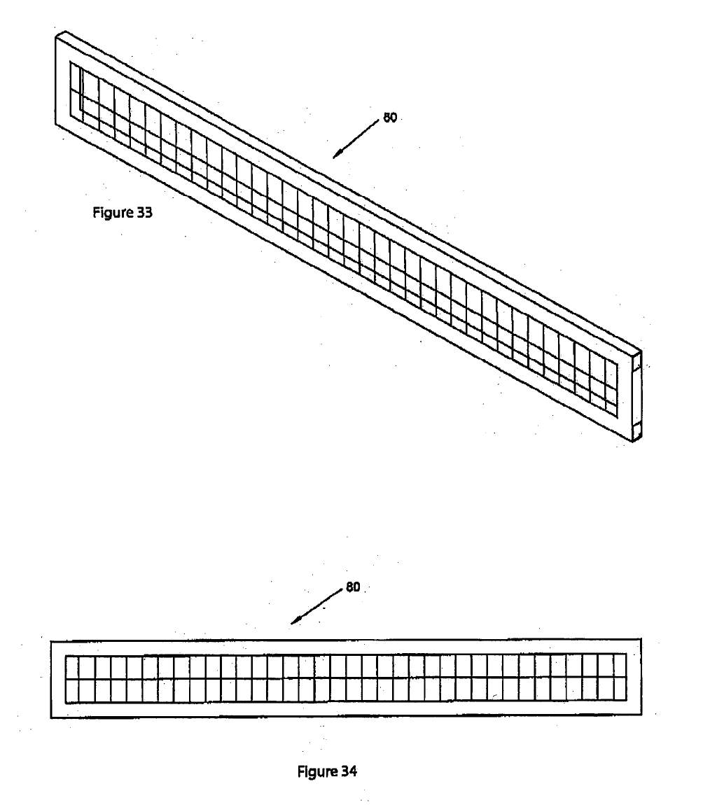

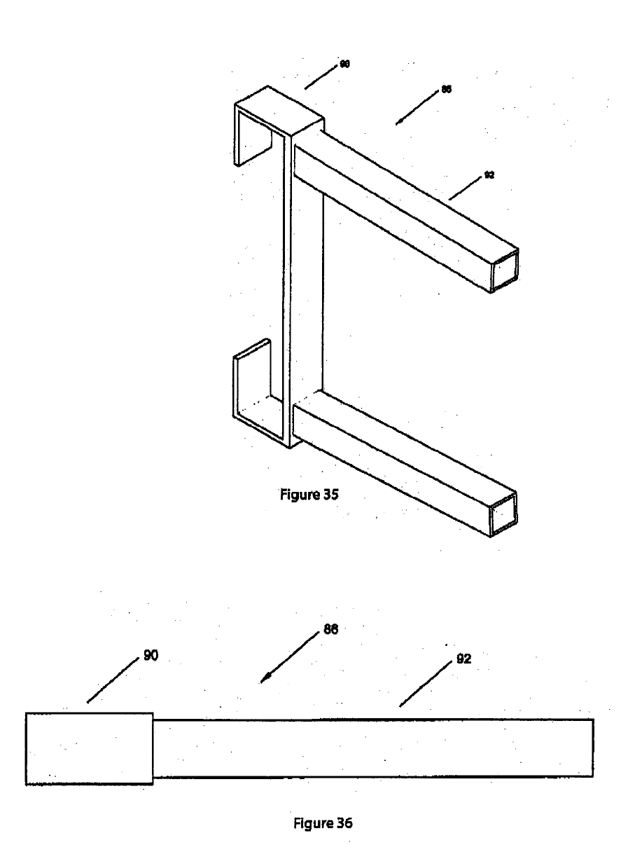

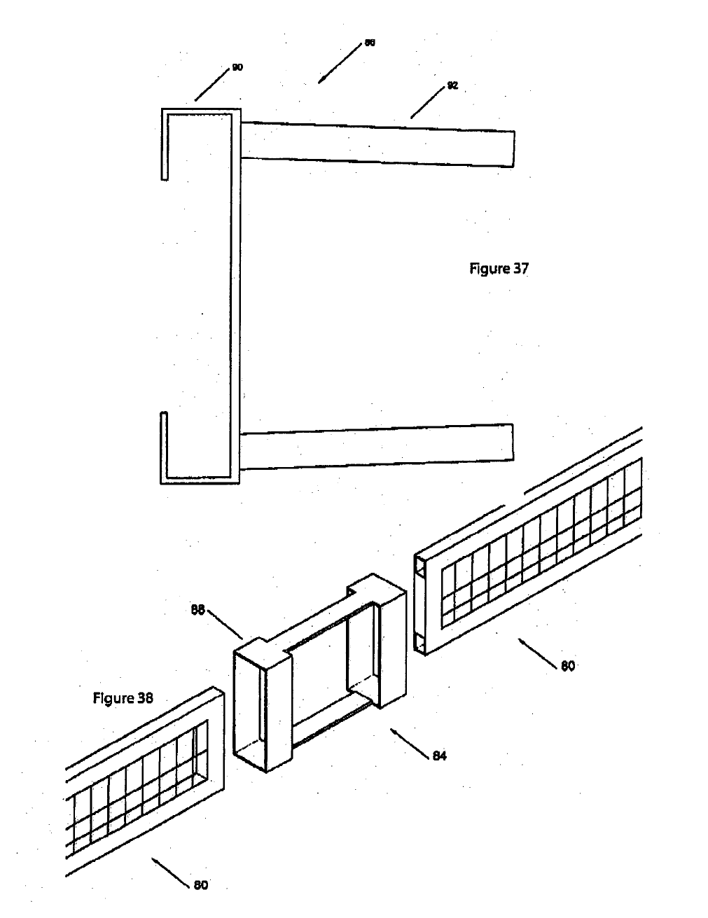

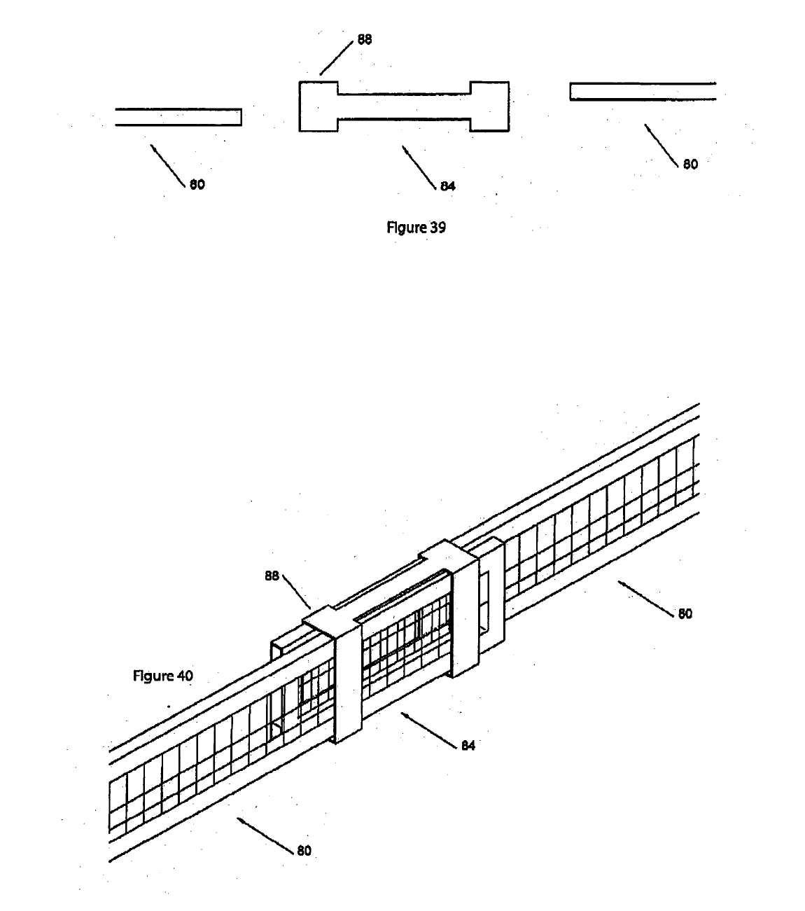

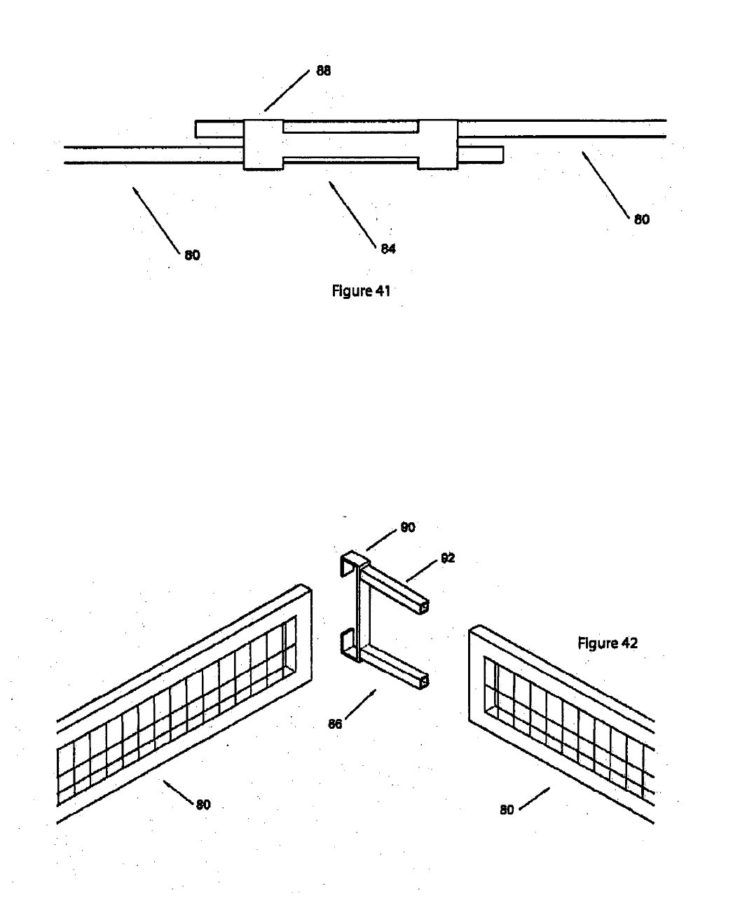

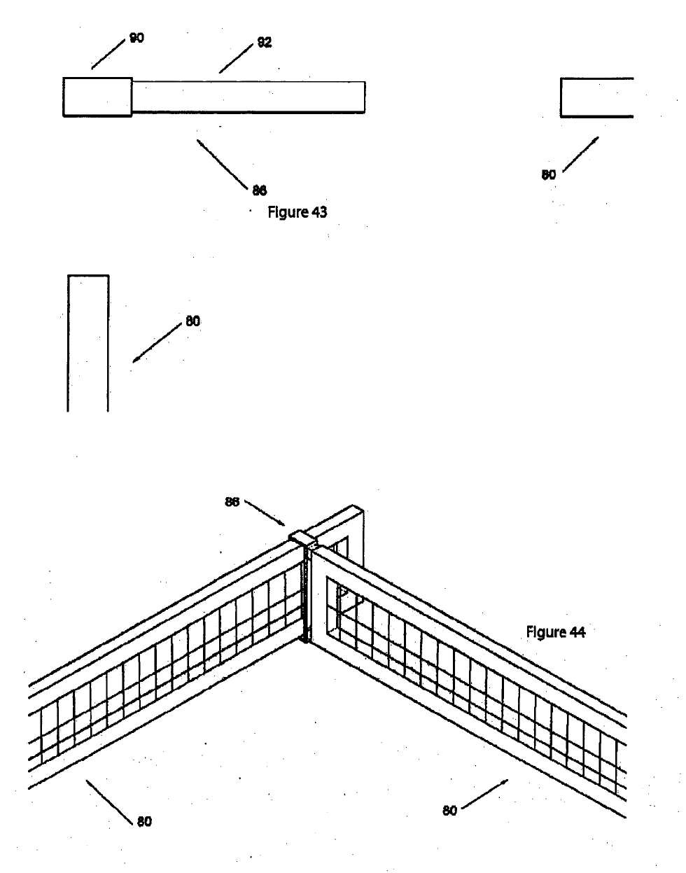

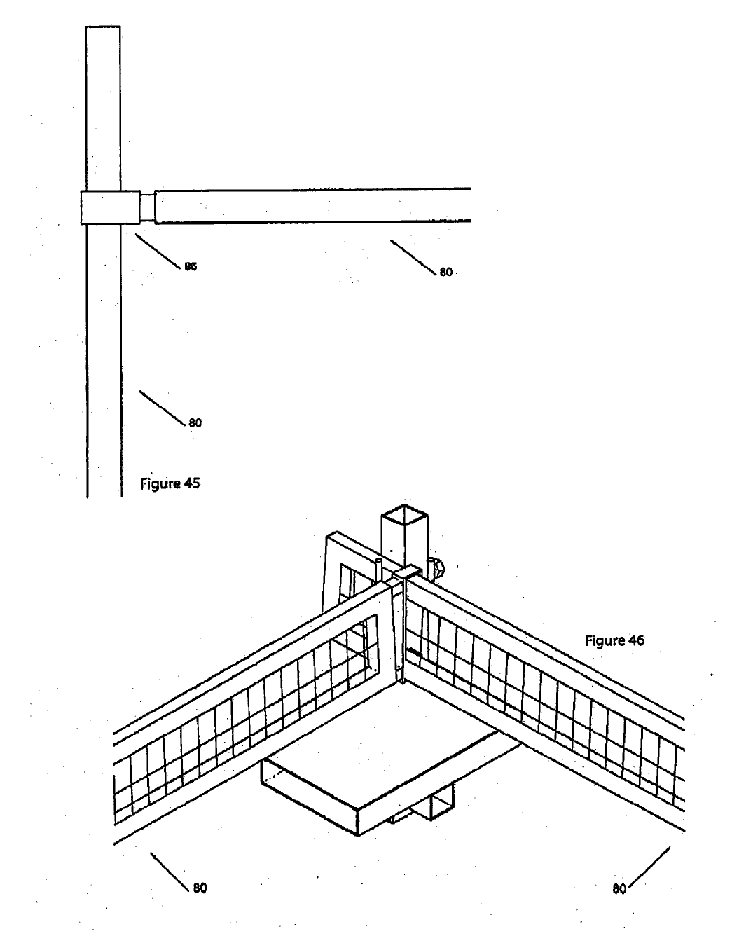

Scaffolding frame assemblies 10 and 48 also include kick boards 80 (see FIGS. 1 to 5 and 33 and 34). Referring to FIGS. 30 to 32 and 35 to 45, the kick boards 80 are joined by a kick board joiner and another kick board joiner in the form of slide chassis 84 and corner slide 86 respectively. The slide chassis 84 comprises bands in the form of straps 88. The corner slide 86 comprises opposed hooks and tubes in the form of strap 90 and square sectioned tubes 92. It will be readily apparent from the figures to a person skilled in the relevant art how the kick boards are assembled.

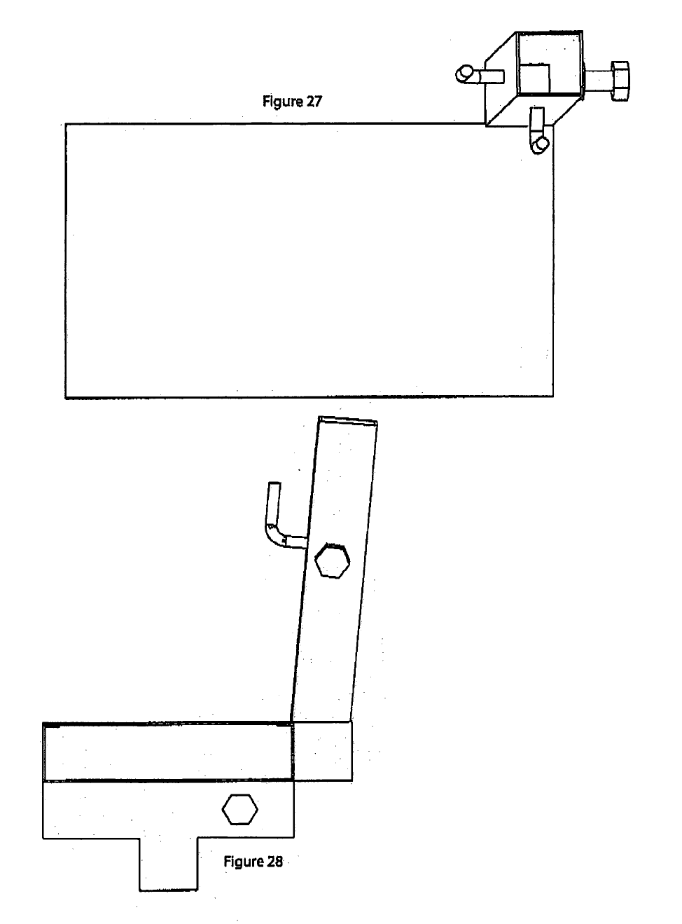

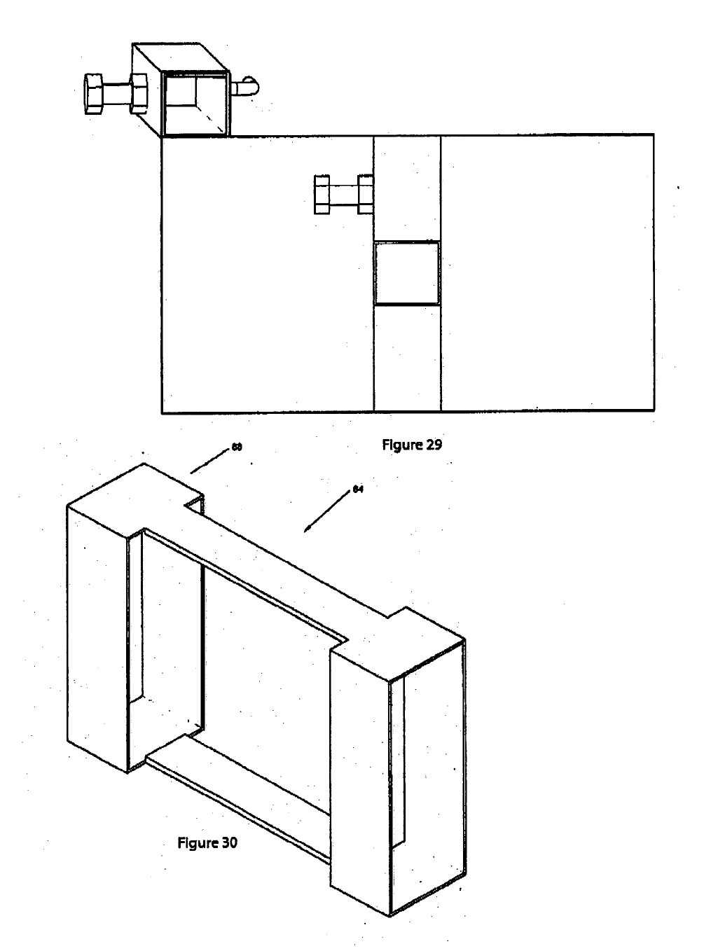

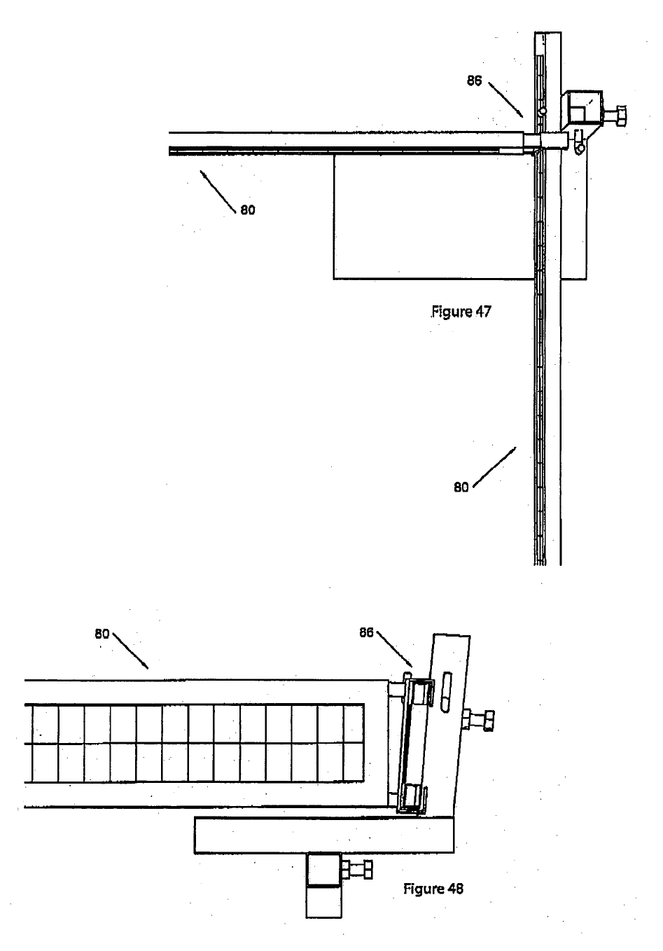

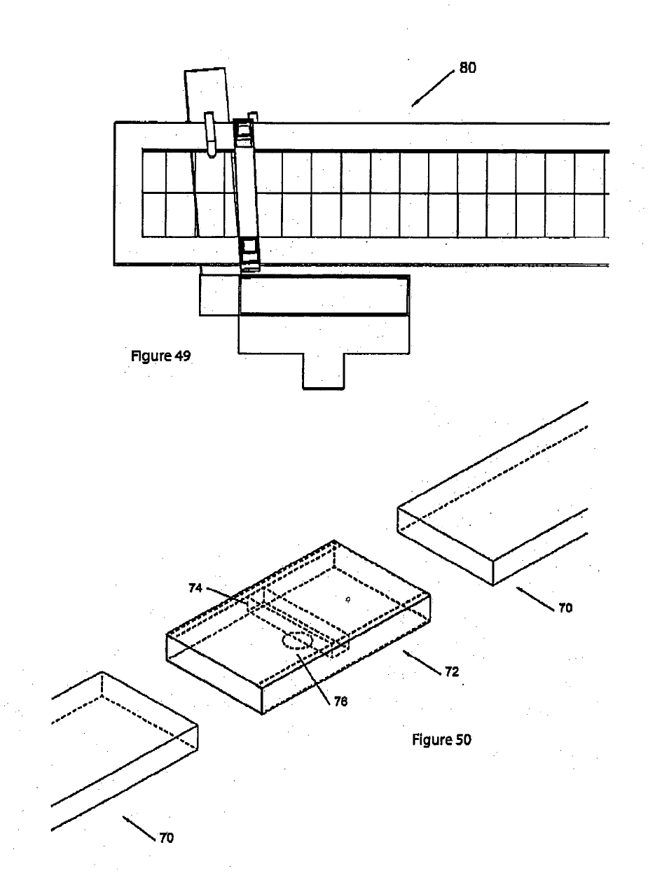

Referring to FIGS. 26 to 29 and 46 to 49, scaffolding frame assemblies 10 and 48 can also include a corner sleeve 100 and corresponding support post (not shown). One example of a corner sleeve 100 is visible in FIGS. 3a and 3b and slidably receives a plank 70 and support post in a manner that will be readily apparent to a person skilled in the relevant art. It will be appreciated by a person skilled in the relevant art that the invention in at least its preferred form has at least the following advantages:
1. A main support of the modular scaffolding frame assembly of the present invention can be attached to a top plate of a building frame from either inside or outside the building frame
2. The modular scaffolding frame assembly comprises a main support load distributor or load distribution member which transfers load supported by the main support to two or more wall studs of the building frame
3. The modular scaffolding frame comprises an adjustable rail support for adjustment of rails which are positioned above a platform of the modular scaffolding frame assembly so that they are positioned either closer to or further away from a wall frame which the modular scaffolding frame assembly is mounted to
4. A support arm of the modular scaffolding frame is designed for detachment from a main support of the modular scaffolding frame assembly facilitating attachment of the frame assembly to a building frame
5. The main support load distributor is also detachable from the main support to further facilitate attachment of the frame assembly to a building frame
6. The support arm is adjustable along the length of the main support tube to enhance platform support adjustability
7. Plank joiners that enable planks, for example those of a scaffolding frame, to be readily and securely joined
8. Kick board joiners that enable kick boards, for example those of a scaffolding frame, to be readily and securely joined.

It will appreciated by persons skilled in the art that numerous variations and/or modifications may be made to the invention as shown in specific embodiments without departing from the spirit or scope of the invention broadly described. For example, different members of a preferred embodiment of the modular scaffolding frame assembly such as the main support and support arm could be foldably connected. This foldable connection should also enable the support arm to be unfolded to a platform support position. It would also preferably allow the main support to be alternately orientated relative to the support arm for attachment of the main support to a top plate of a building frame either from inside or outside the building frame. Other alternative embodiments include, for example, different shaped support arms. They could also comprise members similar to those of preferred embodiments of the modular scaffolding frame assembly but, for example, with tubes of different shaped cross sections or, where appropriate, equivalent solid components. The present embodiments are, therefore, to be considered in all respects as illustrative and not restrictive.

1. A method of erecting scaffolding comprising the steps of:
a. considering whether to attach a scaffolding frame main support member to a top plate of an unlined building frame from a position which is inside an unlined wall of the building frame, and alternatively, from a position which is outside the building frame wall, the scaffolding frame main support member having an elongate portion and being arranged for connecting a platform support member of a scaffolding frame to a top plate of a building frame for support of the platform support member outside the building frame via the top plate; and
b. attaching the scaffolding frame main support member to the top plate so that the elongate portion of the main support member is positioned on the side of the building frame wall from which the main support member was attached.

2. A method as claimed in claim 1 further comprising the step of attaching the main support member to a top plate of a building frame so that it is positioned either substantially over a wall stud or any other position along the top plate.

3. A method as claimed in claim 2 wherein the platform support is attached to the main support before the main support is attached to the top plate.

4. A method as claimed in claim 1 further comprising the step of attaching a main support load distribution member to the main support member wherein the main support load distribution member is arranged to distribute load transferred to the main support member from the platform support to at least two wall studs.

5-81. (canceled)

82. A method as claimed in claim 2 further comprising the step of attaching a main support load distribution member to the main support member wherein the main support load distribution member is arranged to distribute load transferred to the main support member from the platform support to at least two wall studs.

83. A method as claimed in claim 3 further comprising the step of attaching a main support load distribution member to the main support member wherein the main support load distribution member is arranged to distribute load transferred to the main support member from the platform support to at least two wall studs.

84. A method as claimed in claim 4 further comprising the step of attaching the scaffolding frame main support member to the top plate from a position which is inside an unlined wall of the building frame, and alternatively, from a position which is outside the building frame wall.

85. A method as claimed in claim 4 wherein the scaffolding frame main support member comprises an elongate portion.

86. A method as claimed in claim 85 further comprising the step of attaching the scaffolding frame main support member to the top plate so that the elongate portion of the main support member is positioned on the side of the building frame wall from which the main support member was attached.

87. A method of erecting scaffolding comprising the steps of:
a. attaching a scaffolding frame main support member to a top plate of an unlined building frame, the scaffolding frame main support member being arranged for connecting a platform support member of a scaffolding frame to a top plate of a building frame for support of the platform support member via the top plate; and
b. attaching a main support load distribution member to the main support member, either before or after the main support member is attached to the top plate, wherein the main support load distribution member is arranged to distribute load transferred, to the main support from the platform support, to at least two wall studs.

88. A method as claimed in claim 87 further comprising the step of supporting the platform support member outside the building frame.

89. A method as claimed in claim 87 further comprising the step of attaching the scaffolding frame main support member to the top plate from a position which is inside an unlined wall of the building frame, and alternatively, from a position which is outside the building frame wall.

90. A method as claimed in claim 88 further comprising the step of attaching the scaffolding frame main support member to the top plate from a position which is inside an unlined wall of the building frame, and alternatively, from a position which is outside the building frame wall.

91. A method as claimed in claim 87 wherein the scaffolding frame main support member comprises an elongate portion.

92. A method as claimed in claim 88 wherein the scaffolding frame main support member comprises an elongate portion.

93. A method as claimed in claim 89 wherein the scaffolding frame main support member comprises an elongate portion.

94. A method as claimed in claim 90 wherein the scaffolding frame main support member comprises an elongate portion.

95. A method as claimed in claim 91 further comprising the step of attaching the scaffolding frame main support member to the top plate so that the elongate portion of the main support member is positioned on the side of the building frame wall from which the main support member was attached.

96. A method as claimed in claim 92 further comprising the step of attaching the scaffolding frame main support member to the top plate so that the elongate portion of the main support member is positioned on the side of the building frame wall from which the main support member was attached.

97. A method as claimed in claim 93 further comprising the step of attaching the scaffolding frame main support member to the top plate so that the elongate portion of the main support member is positioned on the side of the building frame wall from which the main support member was attached.

98. A method as claimed in claim 94 further comprising the step of attaching the scaffolding frame main support member to the top plate so that the elongate portion of the main support member is positioned on the side of the building frame wall from which the main support member was attached.

99. A scaffolding frame main support member arranged for connecting a platform support member of a scaffolding frame to a top plate of a building frame and support of the platform support member via the top plate wherein the scaffolding frame main support member is arranged for attachment to the top plate from inside, and alternatively outside, the building frame and support of the platform support outside the building frame.

100. A scaffolding frame main support member as claimed in claim 99 further comprising a U-Shaped attachment portion.

101. A scaffolding frame main support member as claimed in claim 100 wherein the U-shaped attachment portion comprises a U-shaped channel.

102. A scaffolding frame main support member as claimed in claim 100 wherein the U-shaped attachment portion further comprises main support location means for locating the main support relative to the top plate.

103. A scaffolding frame main support member as claimed in claim 101 wherein the U-shaped attachment portion further comprises main support location means for locating the main support relative to the top plate.

104. A scaffolding frame main support member as claimed in claim 99 arranged for attachment to a top plate of a building frame so that it is positioned either substantially over a wall stud or any other position along the top plate.

105. A scaffolding frame main support member as claimed in claim 100 arranged for attachment to a top plate of a building frame so that it is positioned either substantially over a wall stud or any other position along the top plate.

106. A scaffolding frame main support member as claimed in claim 101 arranged for attachment to a top plate of a building frame so that it is positioned either substantially over a wall stud or any other position along the top plate.

107. A scaffolding frame main support member as claimed in claim 102 arranged for attachment to a top plate of a building frame so that it is positioned either substantially over a wall stud or any other position along the top plate.

108. A scaffolding frame main support member as claimed in claim 103 arranged for attachment to a top plate of a building frame so that it is positioned either substantially over a wall stud or any other position along the top plate.

109. A scaffolding frame main support member as claimed in claim 100 wherein the main support member is elongate.

110. A scaffolding frame main support member as claimed in claim 99 wherein the main support member is elongate.

111. A scaffolding frame main support member as claimed in claim 100 wherein the main support member is elongate.

112. A scaffolding frame main support member as claimed in claim 101 wherein the main support member is elongate.

113. A scaffolding frame main support member as claimed in claim 102 wherein the main support member is elongate.

114. A scaffolding frame main support member as claimed in claim 103 wherein the main support member is elongate.

115. A scaffolding frame main support member as claimed in claim 104 wherein the main support member is elongate.

116. A scaffolding frame main support member as claimed in claim 105 wherein the main support member is elongate.

117. A scaffolding frame main support member as claimed in claim 106 wherein the main support member is elongate.

118. A scaffolding frame main support member as claimed in claim 107 wherein the platform support member is arranged for engagement along at least part of the elongate length of the main support.

119. A scaffolding frame main support load distribution member arranged for attachment to a main support member of a scaffolding frame, the main support member being arranged for connecting a platform support member of a scaffolding frame to a top plate of a building frame and support of the platform support member via the top plate, wherein the main support load distribution member is arranged for distributing across at least two studs of the building frame load transferred, when the main support member is attached to the top plate and supporting the platform support, from the platform support to the main support.

120. A scaffolding frame main support load distribution member as claimed in claim 119 further comprising a load distribution rail arranged for contacting the two or more studs when the main support is attached to the building frame top plate.

121. A scaffolding frame main support load distribution member as claimed in claim 120 wherein the load distribution rail is arranged for removable slidable engagement with the remainder of the main support load distribution member.

122. A rail joiner, the rail joiner having one or more receptacles arranged to join end portions of substantially collinear rails in abutting, and alternatively, overlapping relationship to provide a joined rail.

123. A rail joiner as claimed in claim 122 wherein the one or more receptacles comprise connected bands for connecting two or more rails, one of the bands being arranged for location within or passage there through of an end of a rail, and alternatively, an end of the rail and ends of one or more other rails, and the other band being arranged for location within or passage there through of ends of the one or more other rails, and alternatively, ends of the one or more other rails and an end of the rail.

124. A rail joiner as claimed in claim 123 wherein the bands are rectangular in cross section.

125. A rail joiner as claimed in claim 122 wherein the rail joiner is a kick board joiner arranged to join kick boards.

126. A rail joiner as claimed in claim 123 wherein the rail joiner is a kick board joiner arranged to join kick boards.

127. A rail joiner as claimed in claim 124 wherein the rail joiner is a kick board joiner arranged to join kick boards.

128. A deck joiner, the deck joiner having one or more receptacles arranged to join edges of two or more substantially coplanar decks in abutting relationship to provide a joined deck.

129. A deck joiner as claimed in claim 128 wherein the one or more receptacles comprise a sleeve arranged to receive and locate therein the deck edges.

130. A deck joiner as claimed in claim 129 wherein the sleeve comprises a deck edge locator which is arranged to locate ends of the deck edges substantially midway along the longitudinal length of the sleeve.

131. A deck joiner as claimed in claim 128 wherein the deck joiner is a plank joiner arranged to join end edges of two substantially coplanar planks in abutting relationship to provide joined planks.

132. A deck joiner as claimed in claim 129 wherein the deck joiner is a plank joiner arranged to join end edges of two substantially coplanar planks in abutting relationship to provide joined planks.

133. A deck joiner as claimed in claim 130 wherein the deck joiner is a plank joiner arranged to join end edges of two substantially coplanar planks in abutting relationship to provide joined planks.
